(19) United States
(12) Patent Application Publication
(10) Pub. No.: US 2019/0103908 A1
(43) Pub. Date: Apr. 4, 2019

(54) Method for Uplink Beam Indication for Wireless Communication System with Beamforming

(71) Applicant: MEDIATEK INC., Hsinchu (TW)

(72) Inventors: Chia-Hao Yu, Hsinchu (TW); Cheng-Rung Tsai, Hsinchu (TW); Ming-Po Chang, Hsinchu (TW); Jiann-Ching Guey, Hsinchu (TW)

(21) Appl. No.: 16/145,855

(22) Filed: Sep. 28, 2018

Related U.S. Application Data
(60) Provisional application No. 62/567,014, filed on Oct. 2, 2017.

(51) Int. Cl. H04B 7/08; H04W 24/10; H04W 72/04; H04B 7/06

(52) U.S. Cl. CPC H04B 7/0851; H04W 24/10; H04B 7/0617; H04W 72/046; H04W 72/0413

(57) ABSTRACT

A method of uplink beam indication for uplink transmission in a beamforming network is proposed. After entering connected mode, both downlink and uplink have a default beam pair link (BPL). Based on uplink beam management, the network establishes mapping between uplink beam indication states and reference signal (RS) resources. The network then signals the uplink beam indication states mapping to UE. UE performs subsequent uplink transmission based on the uplink beam indication, where UE determines its TX beams by mapping from RS resources to corresponding UE TX beams. The uplink beam indication is updated whenever a mapping between a beam indication state to a UE TX beam is changed.

### CROSS REFERENCE TO RELATED APPLICATIONS

This application claims priority under 35 U.S.C. § 119 from U.S. Provisional Application No. 62/567,014, entitled “Mechanism for UL Beam Indication,” filed on Oct. 2, 2017; the subject matter of which is incorporated herein by reference.

### TECHNICAL FIELD

The disclosed embodiments relate generally to wireless communication, and, more particularly, to uplink beam management and indication in a Millimeter Wave (mmWave) beamforming system.

### BACKGROUND

The bandwidth shortage increasingly experienced by mobile carriers has motivated the exploration of the underutilized Millimeter Wave (mmWave) frequency spectrum around 30G and 300G Hz for the next generation broadband cellular communication networks. The available spectrum of mmWave band is hundreds of times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

With recent advances in mmWave semiconductor circuitry, mmWave wireless system has become a promising solution for real implementation. However, the heavy reliance on directional transmissions and the vulnerability of the propagation environment present particular challenges for the mmWave network. In general, a cellular network system is designed to achieve the following goals: 1) Serve many users with widely dynamical operation conditions simultaneously; 2) Robust to the dynamics in channel variation, traffic loading and different QoS requirement; and 3) Efficient utilization of resources such as bandwidth and power. Beamforming adds to the difficulty in achieving these goals.

In principle, beam training mechanism, which includes both initial beam alignment and subsequent beam tracking, ensures that base station (BS) beam and user equipment (UE) beam are aligned for data communication. In downlink DL-based beam management (BM), the BS side provides opportunities for UE to measure beamformed channel of different combinations of BS beams and UE beams. For example, BS performs periodic beam sweeping with reference signal (RS) carried on individual BS beams. UE can collect beamformed channel state by using different UE beams and report the collect information to BS. Similarly, in uplink UL-based BM, the UE side provides opportunities for BS to measure beamformed channel of different combinations of UE beams and BS beams. For example, the UE performs periodic beam sweeping with sounding reference signal (SRS) carried on individual UE beams. BS can collect beamformed channel state by using different BS beams and report the collect information to the UE.

For UL transmission, a beam indication (BI) mechanism is needed for UE to determine its TX beam for later UL transmission. The transmission that may need BI assistance includes SRS transmission for UL beam management and/or channel state information (CSI) acquisition, UL control channel transmission, and UL data channel transmission. A framework is needed for signaling of UE TX beam(s) that is selected for UL transmission, establishing the set of UE TX beam(s) suitable for UL transmission, and maintaining the set of UE TX beam(s) suitable for UL transmission.

### SUMMARY

A method of uplink beam indication for uplink transmission in a beamforming network is proposed. After entering connected mode, both downlink and uplink have a default beam pair link (BPL). Based on uplink beam management, the network establishes mapping between uplink beam indication states and reference signal (RS) resources. The network then signals the uplink beam indication states mapping to UE. UE performs subsequent uplink transmission based on the uplink beam indication, where UE determines its TX beams by mapping from RS resources to corresponding UE TX beams. The uplink beam indication is updated whenever a mapping between a beam indication state to a UE TX beam is changed.

In one embodiment, a UE receives a beam management (BM) configuration from a BS in a beamforming wireless communication network. The BM configuration comprises allocated reference signal (RS) resources for a BM procedure. The UE receives a beam indication table from the base station. The beam indication table comprises mappings between beam indication states and corresponding uplink reference signal indexes. The UE performs an uplink transmission based on the beam indication table. The UE maps each uplink reference signal index to a UE TX spatial filter for the uplink transmission.

In another embodiment, a BS transmits a beam management (BM) configuration to a user equipment (UE) in a beamforming wireless communication network. The BM configuration comprises allocated reference signal (RS) resources for a BM procedure. The BS establishes and transmits a beam indication table in accordance with a result of the BM procedure. The beam indication table comprises mappings between beam indication indexes and corresponding uplink reference signal indexes. The BS receives an uplink transmission from the UE based on the beam indication table. The base station maps each uplink reference signal index to a BS RX spatial filter for the uplink transmission.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a Millimeter Wave beamforming wireless communication system with uplink beam indication in accordance with one novel aspect.

FIG. 2 is a simplified block diagram of a base station and a user equipment (UE) that carry out certain embodiments of the present invention.

FIG. 3 illustrates a procedure between a base station and a UE for uplink (UL) beam indication in accordance with one novel aspect.

FIG. 4 illustrates examples of using UL RS resource index and transmission configuration indication (TCI) for UL beam indication.

FIG. 5 illustrates a first embodiment of establishment of UL beam indication.

FIG. 6 illustrates a second embodiment of establishment of UL beam indication.

FIG. 7 illustrates a first embodiment of maintenance of UL beam indication.

FIG. 8 illustrates a second embodiment of maintenance of UL beam indication.

FIG. 9 illustrates a third embodiment of maintenance of UL beam indication.

FIG. 10 illustrates another example of beam indication state update.

FIG. 11 is a flow chart of a method of uplink beam indication from UE perspective in a beamforming wireless network in accordance with one novel aspect.

FIG. 12 is a flow chart of a method of uplink beam indication from BS perspective in a beamforming wireless network in accordance with one novel aspect.

### DETAILED DESCRIPTION

Reference will now be made in detail to some embodiments of the invention, examples of which are illustrated in the accompanying drawings.

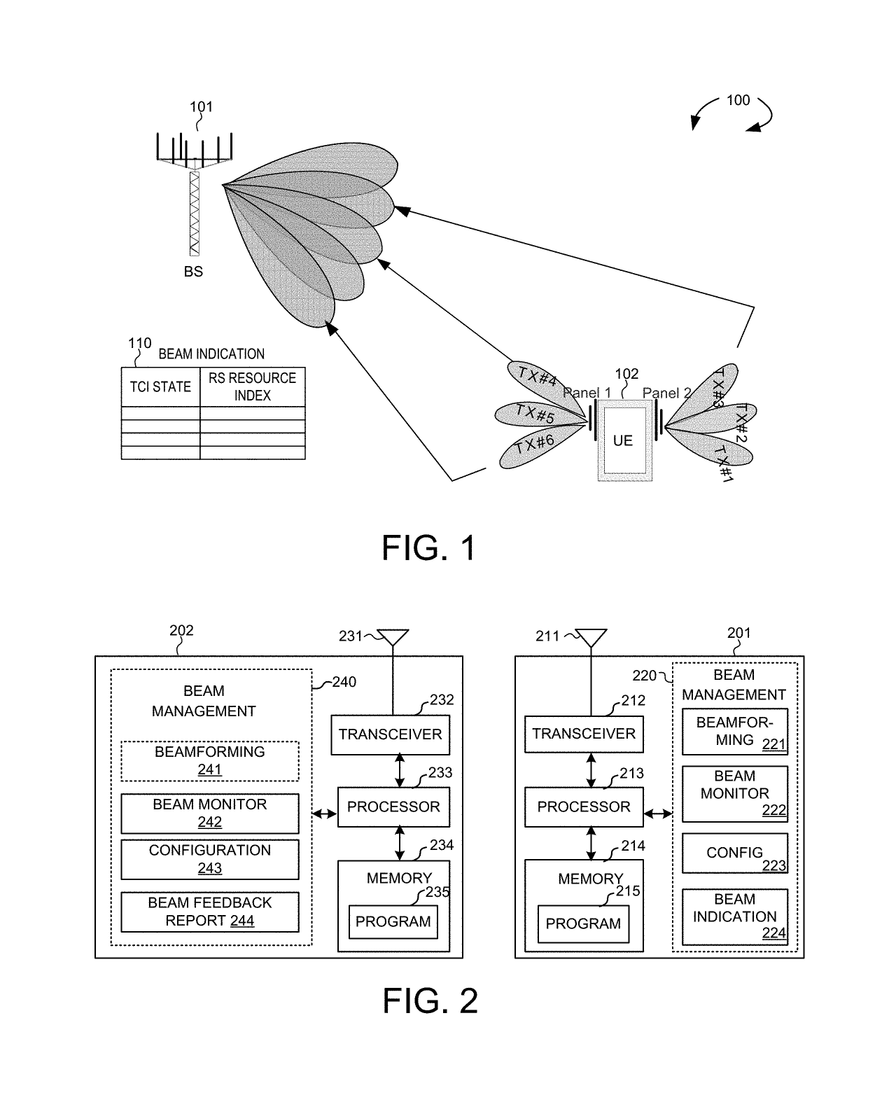

FIG. 1 illustrates a Millimeter Wave beamforming wireless communication system 100 with uplink beam indication in accordance with one novel aspect. Beamforming mmWave mobile communication network 100 comprises a base station BS 101 and a user equipment UE 102. The mmWave cellular network 100 uses directional communication with narrow beams and can support multi-gigabit data rate. Directional communication is achieved via digital and/or analog beamforming, wherein multiple antenna elements are applied with multiple sets of beamforming weights to form multiple beams. Different beamformers apply different spatial filters and have different spatial resolution, i.e., beamwidth. For example, a sector antenna can form beams having lower array gain but wider spatial coverage, while a beamforming antenna can have higher array gain but narrower spatial coverage. The beamformer and TX/RX beam mentioned here is also referred to as a spatial filter, and it can be interchangeably used.

The purpose of downlink (DL) and uplink (UL) beam training is to decide a proper beam pair link (BPL) between a BS and a UE for communication. In uplink UL-based beam management, the UE side provides opportunities for BS to measure beamformed channel of different combinations of UE beams and BS beams. For example, UE performs periodic beam sweeping with reference signal (RS) carried on individual UE beams. BS can collect beamformed channel state by using different BS beams and report the collected information to UE. In the example of FIG. 1, BS 101 provides uplink (UL) RS resource configuration for UL beam management. UE 102 then transmits UL RS using different UE TX beams over the configured UL RS resources. BS 101 performs measurements and reports one or more BPLs with corresponding measurement metric(s).

In according with one novel aspect, a beam indication mechanism is proposed for UE to determine its TX beam or spatial filter for later UL transmission. The transmission that may need BI assistance includes RS transmission for UL beam management and/or channel state information (CSI) acquisition, UL control channel transmission, and UL data channel transmission. A framework is provided for signaling of UE TX beam(s) that is selected for UL transmission, establishing the set of UE TX beam(s) suitable for UL transmission, and maintaining the set of UE TX beam(s) suitable for UL transmission. In one example, a beam indication as depicted by mapping table 110 is provided from BS 101 to UE 102. UL beam indication can be achieved through 1) UL RS resource index directly, 2) a mapping between beam indication state and UL RS resource, or 3) DL beam indication state directly when beam correspondence holds.

FIG. 2 is a simplified block diagram of a base station and a user equipment that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules that carry out different tasks in accordance with embodiments of the current invention.

Similarly, UE 202 has an antenna 231, which transmits and receives radio signals. A RF transceiver module 232, coupled with the antenna, receives RF signals from antenna 231, converts them to baseband signals and sends them to processor 233. RF transceiver 232 also converts received baseband signals from processor 233, converts them to RF signals, and sends out to antenna 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, BS 201 comprises a beam management module 220, which further comprises a beamforming circuit 221, a beam monitor 222, a configuration circuit 223, and a beam indication circuit 224. Beamforming circuit 221 may belong to part of the RF chain, which applies various beamforming weights to multiple antenna elements of antenna 211 and thereby forming various beams. Beam monitor 222 monitors received radio signals and performs measurements of the radio signals transmitted over the various UE beams. Configuration circuit 223 allocates RS resource, configures and triggers different UL BM procedures, and beam indication circuit 224 provides established BPLs and beam indication states to UE.

Similarly, UE 202 comprises a beam management module 240, which further comprises a beamforming circuit 241, a beam monitor 242, a configuration circuit 243, and a beam feedback and report circuit 244. Beamforming circuit 241 may belong to part of the RF chain, which applies various beamforming weights to multiple antenna elements of antenna 231 and thereby forming various beams. Beam monitor 242 monitors received radio signals and performs measurements of the radio signals over the various beams. Configuration circuit 243 receives radio resources and beam indication information for UE measurements and reporting behavior and data transmission. Beam feedback and report circuit 244 provide beam quality metric and send report to BS 201 based on the beam monitoring results for each BPL. Overall, beam management circuit 240 performs UL beam training and management procedures to provide UE antenna capability, to transmit reference signals over configured RS resources over different UE beams, and to enable BS to determine selected BPLs and beam indication for subsequent data transmission.

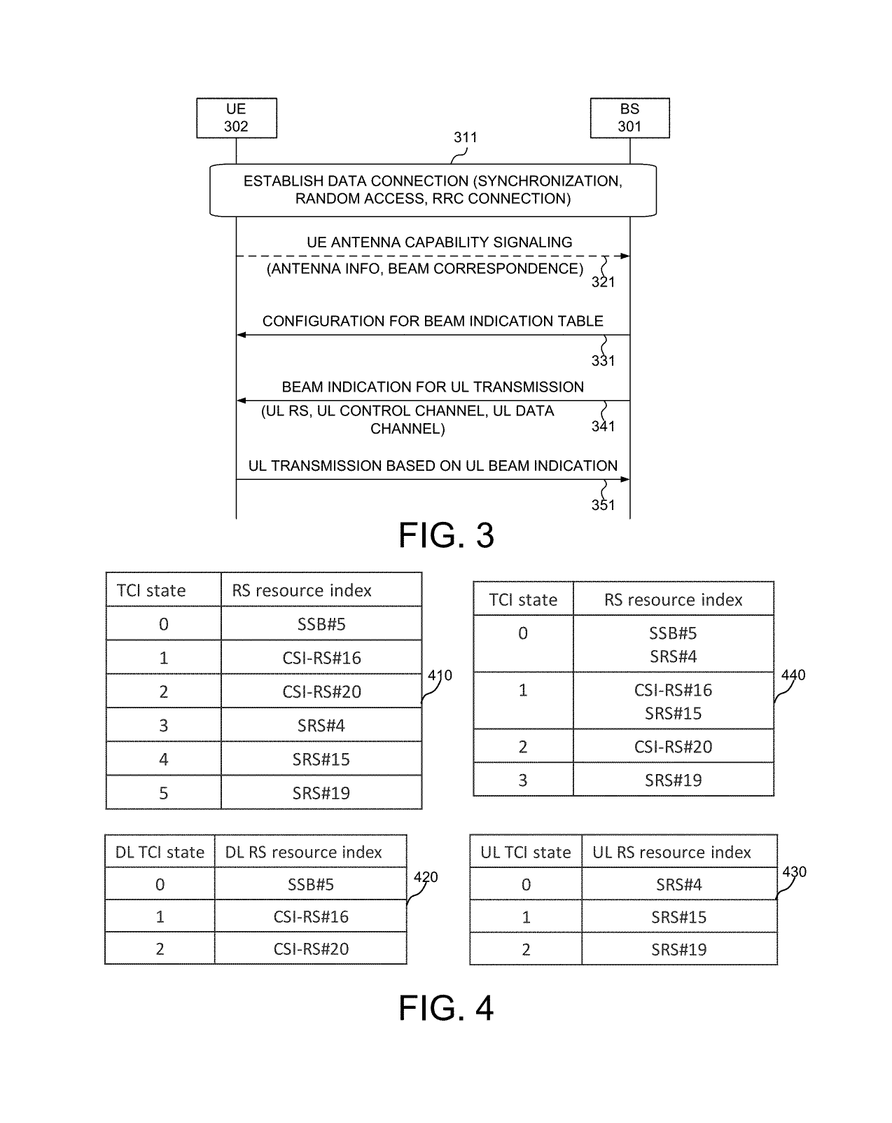

FIG. 3 illustrates a procedure for uplink (UL) beam indication in accordance with one novel aspect. Initially, UE 302 performs scanning, beam selection, and synchronization with BS 301 using periodically configured control beams. In step 311, BS 301 and UE 302 establish a data connection over a trained dedicated data beam based on a beam training operation (after synchronization, random access, and RRC connection establishment). In step 321, UE 302 provides UE antenna capability signaling to BS 301 (optional). The antenna capability information comprises number of required UL RS resource groups, i.e., a number of UE antenna groups or panels, a number of UE beams per group, and beam correspondence state. When BS needs to determine multiple UL BPLs for higher rank transmission or multi-TRP transmission, enough information needs to be provided to BS so that BS does not select UE TX beams that cannot be realized at the same time.

In step 331, BS 301 provides UE 302 configuration related to beam indication table. The configuration comprises UL RS resource configuration, UL RS transmission information, etc. In step 341, BS 301 provides beam indication for UL transmission. The beam indication can be UL RS, UL control channel, UL data channel. The beam indication can refer to purely DL RS, or purely UL RS, or both DL and UL RSs. In step 351, UE 302 performs corresponding UL transmission based on the configuration and the beam indication.

FIG. 4 illustrates examples of using UL RS resource index and transmission configuration indication (TCI) for UL beam indication. Beam indication can be achieved through the following options: 1) UL RS resource index directly; 2) Beam indication state similar to TCI state used for DL beam indication, a mapping between the state and UL RS resource is needed; or 3) DL TCI state directly, i.e., use DL beam indication as UL indication when UE beam correspondence holds.

If UL beam indication is through beam indication state similar to TCI state used for DL indication, then the UL beam indication can be categorized into a shared table (e.g., table 410) or two separate tables (e.g., tables 420 and 430). Shared table 410 can accommodate both a mapping between a TCI state with a DL RS resource and a mapping between a TCI state with a UL RS resource. Separate tables can accommodate either a mapping between a TCI state with a DL RS resource (table 420) or a mapping between a TCI state with a UL RS resource (table 430).

In an alternative design, sharing a same TCI table for DL and UL beam indications can be devised as follows, as depicted by table 440. A TCI state can be mapped to a RS set, which includes both a DL RS resource index and a UL RS resource index. When UL beam indication is signaled with such a TCI state, the UL RS resource index is used to derive a UE TX beam. A TCI state can be mapped to a RS set, which simply includes a DL RS resource index. When UL beam indication is signaled with such a TCI state, the DL resource index is used to derive a UE TX beam. A TCI state can be mapped to a RS set, which simply includes a UL RS resource index. When UL beam indication is signaled with such a TCI state, the UL resource index is used to derive a UE TX beam.

After entering RRC-CONNECTED mode, both DL and UL have a default BPL for communication. The DL and UL default BPLs are identified during, e.g., random access channel (RACH) procedure before entering RRC-CONNECTED mode. The default BPL may be mapped to a default beam indication state, e.g., “000”. When beam correspondence holds for a connected UE, DL beam management (BM) procedure can be used to establish UL beam indication. DL UE RX Beams identified for DL reception can be used for UL UE TX transmission. Both DL reception and UL transmission can use the same default BPL. DL BM procedure is executed for DL beam determination. Table of mapping between TCI states and DL BM RS resources is established and signaled from BS to UE. In UL transmission, results of DL BM can be reused, i.e. DL beam indicator (TCI) can be used for UL beam indication. The value of beam indication field in all downlink control information (DCIs) carried over PDCCHs can be a TCI beam indication state established or updated after DL BM procedure.

In addition, different UL beam management (BM) procedures can be used to establish UL beam indication. A first UL BM procedure enables UE to transmit with sweeping UE TX beams and enables BS to measure with sweeping BS RX beams (U-1). U-1 can be configured as a periodic UL BM procedure, including UL RS configuration containing UL RS resource groups. A second UL BM procedure enables UE to transmit UL RS on a number of UL resources with a fixed UE TX beam, while BS may use different BS RX beams (U-2). Application of a fixed UE TX beam and application of which UE TX beam as the fixed UE TX beam can be signaled from the network. A third UL BM procedure enables UE to transmit UL RS on a number of UL resources with different UE TX beams, while BS may use a fixed BS RX beam (U-3). UL beam indication, e.g., UL beam and UL RS resource index, is signaled to UE with indication to trigger the U-3 procedure.

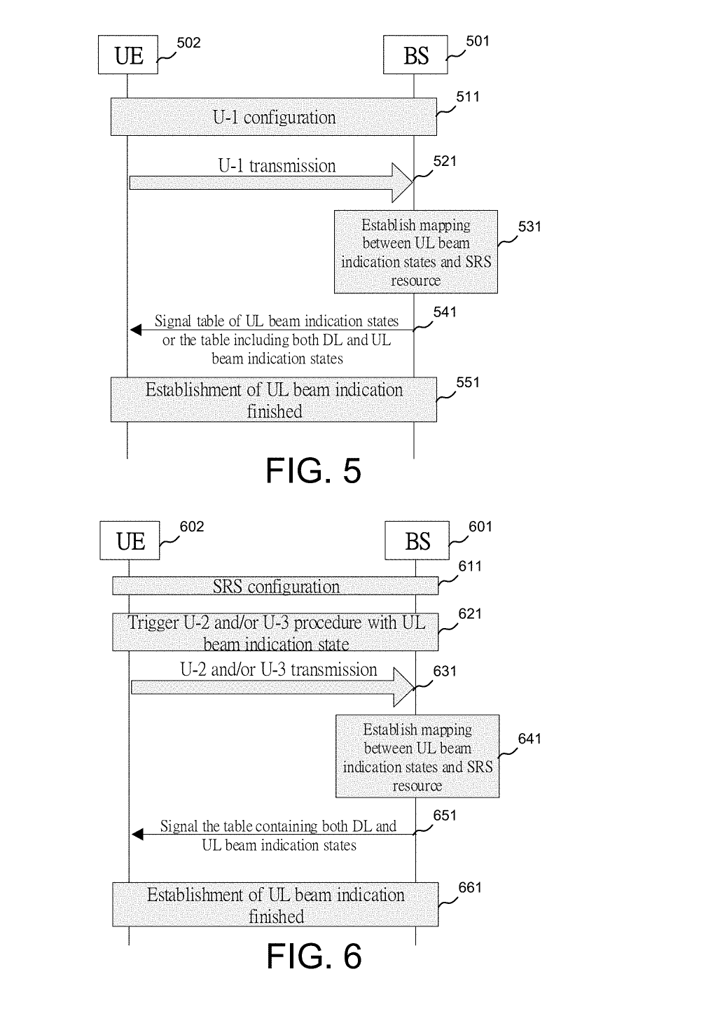

FIG. 5 illustrates a first embodiment of establishment of UL beam indication based on U-1 procedure. BS 501 and UE 502 first establish an RRC connection and default BPL. In step 511, U-1 procedure is configured, e.g., via RRC message. During U-1, BS is able to sweep through its BS RX beams for BM while UE is able to sweep through its UE TX beams for UL RS transmission. U-1 can be configured as a periodic UL BM procedure with UL RS configuration. In step 521, UE 502 transmits UL RS based on the U-1 configuration. In step 531, BS 501 performs measurements and selects a subset of UL BM RS resources which are measured during the U-1 procedure to be associated with UL beam indication states. Mapping between UL beam indication states and the subset of UL BM RS resources is established by BS 501. In step 541, BS 501 signals the table containing both DL and UL beam indication states to UE 502. In step 551, the establishment of UL beam indication is completed. BS 501 can trigger U-2 and/or U-3 for further UL BM on adjacent or refined beams with UL beam indication provided.

FIG. 6 illustrates a second embodiment of establishment of UL beam indication based on U-2/U-3 procedure. BS 601 and US 602 first establish an RRC connection and default BPL. After entering RRC-CONNECTED mode, both DL and UL have a default BPL for communication. The default BPLs for DL and UL can be different. Both DL and UL BM procedures are applied for UL TX beam determination. In step 611, BS 601 configures UL SRS resources for U-2 and/or U-3 procedure. In step 621, BS 601 triggers the U-2 and/or U-3 procedure. Signaling for UL TX beam indication can be signaled together with SRS transmission trigger signaling, signaling for UL TX beam indication can refer to e.g., a TCI state of default UL BPL, signaling for UL TX beam indication can refer to e.g., a DL TCI state. In step 631, UE 602 transmits UL SRS based on the U-2 and/or U-3 configuration. In step 641, BS 601 performs measurements and establishes mapping between UL beam indication states and UL BM SRS resource. In step 651, BS 601 signals the table containing both DL and UL beam indication states to UE 602. In step 661, the establishment of UL beam indication is completed. BS 601 can subsequently trigger more U-2 and/or U-3 for beam refine or beam tracking, with UL beam indication provided in the trigger signaling.

Once the UL beam indication state is established, it also needs to be maintained for selectin of UL BPL. In a first option, the beam indication state is explicitly updated whenever a mapping between beam indication state to BS RX beam or to UE TX beam is changed. For example, U-1, U-2, U-3 can all result in beam indication state update. In a second option, beam indication state is explicitly updated only when spatial QCL assumption for a beam indication state is changed at UE. For example, U-3 may result beam indication state update, but U-2 may not result beam indication state update.

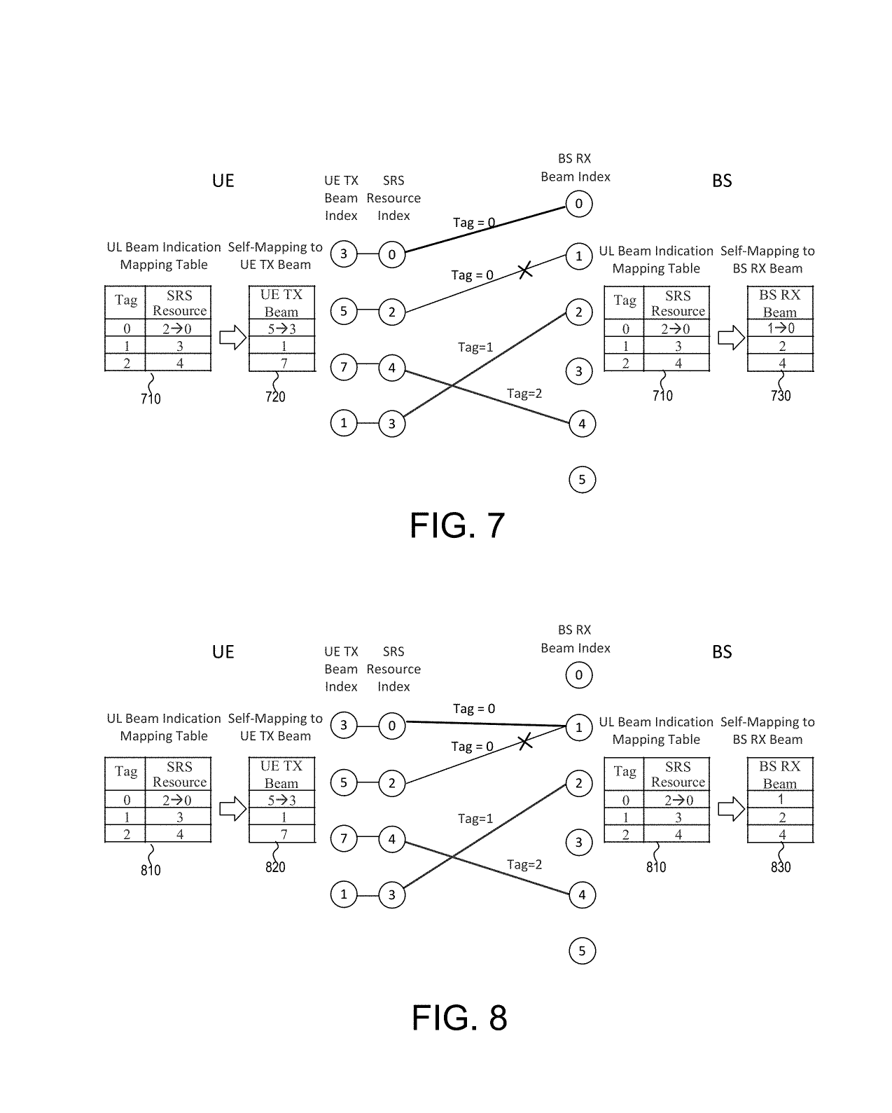

FIG. 7 illustrates a first embodiment of maintenance of UL beam indication. In the example of FIG. 7, the spatial QCL assumption for a beam indication state are changed at both BS and UE, which may result from U-1 and U-3 procedures. As depicted by table 710, the original UL beam indication mapping table comprises mappings from tag 0 to SRS resource 2, tag 1 to SRS resource 3, and tag 2 to SRS resource 4. The updated UL beam indication mapping table comprises mappings from tag 0 to SRS resource 0, tag 1 to SRS resource 3, and tag 2 to SRS resource 4. At UE side, UE self-maps from SRS resource indexes to UE TX beams or spatial filters accordingly (720). At BS side, BS self-maps from SRS resource indexes to BS RX beams accordingly (730). Because the UL beam indication state tag 0 is updated from SRS resource 2 to 0, it results in updated UE TX beam from beam 5 to beam 3 and updated BS RX beam from beam 1 to beam 0.

FIG. 8 illustrates a second embodiment of maintenance of UL beam indication. In the example of FIG. 8, the spatial QCL assumption for a beam indication state are changed at UE, which may result from U-1 and U-3 procedures. As depicted by table 810, the original UL beam indication mapping table comprises mappings from tag 0 to SRS resource 2, tag 1 to SRS resource 3, and tag 2 to SRS resource 4. The updated UL beam indication mapping table comprises mappings from tag 0 to SRS resource 0, tag 1 to SRS resource 3, and tag 2 to SRS resource 4. At UE side, UE self-maps from SRS resource indexes to UE TX beams or spatial filters accordingly (820). At BS side, BS self-maps from SRS resource indexes to BS RX beams accordingly (830). Because tag 0 is updated from SRS resource 2 to 0, it results in updated UE TX beam from beam 5 to beam 3, but the BS RX beam 1 remains to be unchanged.

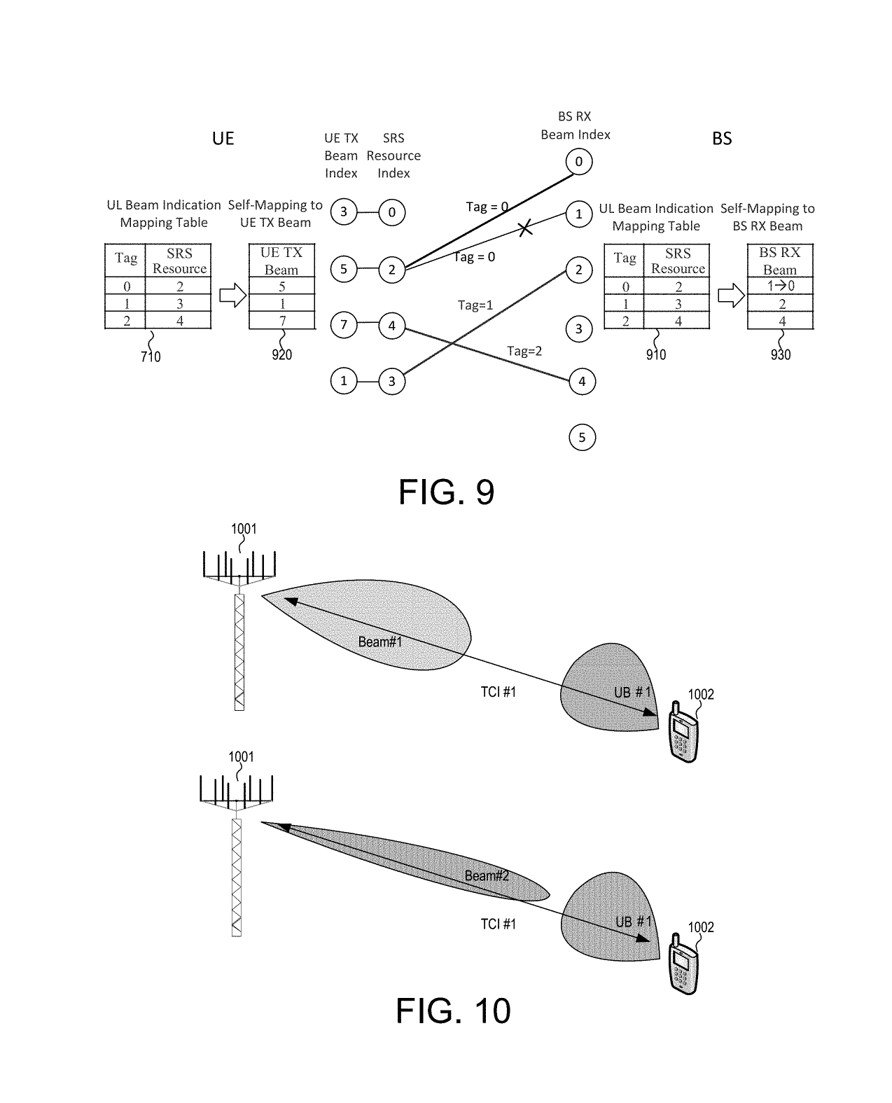

FIG. 9 illustrates a third embodiment of maintenance of UL beam indication. In the example of FIG. 9, the spatial QCL assumption for a beam indication state are changed at BS, which may result from U-2 procedure. As depicted by table 910, the UL beam indication mapping table comprises mappings from tag 0 to SRS resource 2, tag 1 to SRS resource 3, and tag 2 to SRS resource 4. At UE side, UE self-maps from SRS resource indexes to UE TX beams or spatial filters accordingly (920). At BS side, BS self-maps from SRS resource indexes to BS RX beams or spatial filters accordingly (930). For tag 0 and SRS resource 2, the BS RX beam is updated from beam 1 to beam 0. In this case, no explicit update is required.

FIG. 10 illustrates another example of beam indication state update. After the association of UL beam indication states with UL BM RS resources, an UL beam indication state can be mapped to BPL(s). From BS 1001 perspective, an UL beam indication state TCI#1 indicates a RX or a set of RX beams Beam#1 and Beam#2 that can be used to communicate with UE 1002 via corresponding BPL(s). From UE 1002 perspective, an UL beam indication state TCI#1 indicates a TX beam UB#1 or a set of TX beams that can be used to communicate with BS 1001 via corresponding BPL(s). Therefore, from UE perspective, the BS RX beams indicated by an UL beam indication state value are treated as spatially quasi-co-located (QCL-ed), and can be reached if the same set of UE TX beams is used for transmission. In the example of FIG. 10, Beam#1 and Beam#2 are spatially QCL-ed, and need not be differentiated via UL beam indication state.

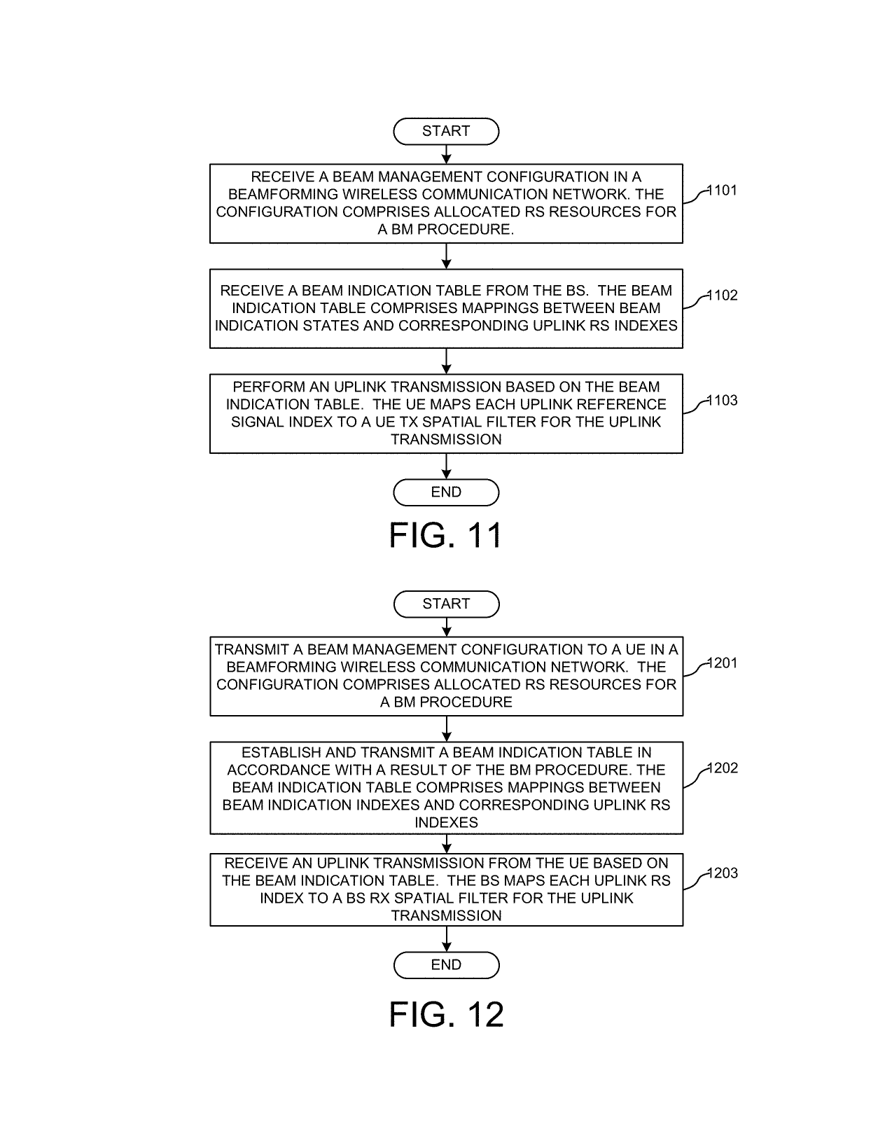

FIG. 11 is a flow chart of a method of uplink beam indication from UE perspective in a beamforming wireless network in accordance with one novel aspect. In step 1101, a UE receives a beam management (BM) configuration from a base station in a beamforming wireless communication network. The BM configuration comprises allocated reference signal (RS) resources for a BM procedure. In step 1102, the UE receives a beam indication table from the base station. The beam indication table comprises mappings between beam indication states and corresponding uplink reference signal indexes. In step 1103, the UE performs an uplink transmission based on the beam indication table. The UE maps each uplink reference signal index to a UE TX spatial filter for the uplink transmission.

FIG. 12 is a flow chart of a method of uplink beam indication from BS perspective in a beamforming wireless network in accordance with one novel aspect. In step 1201, a BS transmits a beam management (BM) configuration to a user equipment (UE) in a beamforming wireless communication network. The BM configuration comprises allocated reference signal (RS) resources for a BM procedure. In step 1202, the BS establishes and transmits a beam indication table in accordance with a result of the BM procedure. The beam indication table comprises mappings between beam indication indexes and corresponding uplink reference signal indexes. In step 1203, the BS receives an uplink transmission from the UE based on the beam indication table. The base station maps each uplink reference signal index to a BS RX spatial filter for the uplink transmission.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a beam management (UL BM) configuration by a user equipment (UE) from a base station in a beamforming wireless communication network, wherein the BM configuration comprises allocated reference signal (RS) resources for a BM procedure;
receiving a beam indication table from the base station, wherein the beam indication table comprises mappings between beam indication states and corresponding uplink reference signal indexes; and
performing an uplink transmission based on the beam indication table, wherein the UE maps each uplink reference signal index to a UE TX spatial filter for the uplink transmission.

2. The method of claim 1, wherein the BM procedure involves UE sweeping through different UE TX spatial filters for one or for multiple times.

3. The method of claim 1, wherein the beam indication table further comprises mappings between beam indication states and corresponding downlink reference signal indexes.

4. The method of claim 1, wherein the UE receives a second beam indication table for mappings between beam indication states and corresponding downlink reference signal indexes.

5. The method of claim 1, wherein each beam indication state is mapped to one uplink reference signal index as well as one downlink reference signal index.

6. The method of claim 1, wherein a beam indication state is mapped to one or more reference signal(s) based on the beam indication table, wherein each of the one or more reference signal(s) is either an uplink or a downlink reference signal.

7. A User Equipment (UE) comprising:
a receiver that receives a beam management (BM) configuration in a beamforming wireless communication network, wherein the BM configuration comprises allocated reference signal (RS) resources for a BM procedure;
a beam management circuit that performing the BM procedure, wherein the UE receives a beam indication table from the base station, wherein the beam indication table comprises mappings between beam indication states and corresponding uplink reference signal indexes; and
a transmitter that transmits an uplink data based on the beam indication table, wherein the UE maps each uplink reference signal index to a UE spatial filter for the uplink data transmission.

8. The UE of claim 7, wherein the BM procedure involves UE sweeping through different UE TX spatial filters for one or for multiple times.

9. The UE of claim 7, wherein the beam indication table further comprises mappings between beam indication states and corresponding downlink reference signal indexes.

10. The UE of claim 7, wherein the UE receives a second beam indication table for mappings between beam indication states and corresponding downlink reference signal indexes.

11. The UE of claim 7, wherein each beam indication state is mapped to one uplink reference signal index as well as one downlink reference signal index.

12. The UE of claim 7, wherein a beam indication state is mapped to one or more reference signal(s) based on the beam indication table, wherein each of the one or more reference signal(s) is either an uplink or a downlink reference signal.

13. A method comprising:
transmitting a beam management (BM) configuration to a user equipment (UE) by a base station in a beamforming wireless communication network, wherein the BM configuration comprises allocated reference signal (RS) resources for a BM procedure;
establishing and transmitting a beam indication table in accordance with a result of the BM procedure, wherein the beam indication table comprises mappings between beam indication indexes and corresponding uplink reference signal indexes; and
receiving an uplink transmission from the UE based on the beam indication table, wherein the base station maps each uplink reference signal index to a BS RX spatial filter for the uplink transmission.

14. The method of claim 13, wherein the BM procedure involves UE sweeping through UE TX spatial filters and/or the base station sweeping through BS RX spatial filters.

15. The method of claim 13, wherein the beam indication table further comprises mappings between beam indication states and corresponding downlink reference signal indexes.

16. The method of claim 13, wherein the base station transmits a second beam indication table for mappings between beam indication states and corresponding downlink reference signal indexes.

17. The method of claim 13, wherein each beam indication state is mapped to one uplink reference signal index as well as one downlink reference signal index.
